(19) United States
(12) Patent Application Publication
(10) Pub. No.: US 2024/0118471 A1
(43) Pub. Date: Apr. 11, 2024

(54) OPTICAL STRUCTURE AND METHOD OF MANUFACTURING IT

(71) Applicants: UNIVERSITE CALAUDE BERNARD LYON 1, Villeurbanne (FR); CENTRE NATIONAL DE LA RECHERCHE SCIENTIFIQUE (CNRS), Paris (FR); ECOLE NORMALE SUPERIEURE DE LYON, Lyon (FR)

(72) Inventors: Stéphane PAROLA, Jonage (FR); Cesar LOPES, Linköping (SE); Denis CHATEAU, Lyon (FR); Frederic CHAPUT, Villeurbanne (FR)

(73) Assignees: UNIVERSITE CALAUDE BERNARD LYON 1, Villeurbanne (FR); CENTRE NATIONAL DE LA RECHERCHE SCIENTIFIQUE (CNRS), Paris (FR); ECOLE NORMALE SUPERIEURE DE LYON, Lyon (FR)

(21) Appl. No.: 17/768,050

(22) PCT Filed: Oct. 15, 2020
(86) PCT No.: PCT/EP2020/079099

§ 371 Date: Apr. 11, 2022

(30) Foreign Application Priority Data
Oct. 17, 2019 (EP) 19290104.9

(51) Int. Cl. G02B 5/28; G02B 1/11; G02F 1/35

(52) U.S. Cl. CPC G02B 5/285; G02B 1/11; G02F 1/3523

(57) ABSTRACT

An optical structure comprising at least one stack having a central filter (1) and two sandwiching optical elements (2,3) between which the central filter (1) is interposed, wherein the central filter (1) is in a matrix material. The matrix material being doped with at least one doping agent, the central filter (1) and the two optical elements (2,3) on either side thereof being assembled by bonding layers (4a, 4b) of a material based on the same matrix material as that of the central filter, the optical elements (2,3) on either side of the central filter (1) and the bonding layers (4a, 4b) each having a refractive index equal to that of the material of the central filter or only differing from this refractive index within a range of plus or minus 0.05, preferably within a range of plus or minus 0.02.

### BACKGROUND OF THE INVENTION

In the field of nonlinear optics, research has been carried out for several years on hybrid materials with non-linear optical properties, in particular for optical limitation applications. These materials are of particular interest when used in optical protection devices (eye, sensors) to prevent damage resulting from laser radiation, the latter being up sharply due to the strong development of technologies associated with lasers.

The advantage of non-linear absorption phenomena ties in the fact that the molecules or materials endowed with these properties react spontaneously under irradiation with very short response times, or reaction times, and very wide wavelength ranges, for example the whole visible or infra-red range for the same material. Commercial fitters, on the other hand, have a narrow wavelength protection band due to linear blocking of light. As lasers today easily can change emitted wavelength, commercial linear blocking filters are becoming obsolete.

One type of hybrid material with known non-linear optical properties comprises a silicated based matrix incorporating molecules, complexes and/or nanoparticles. WO 2011/128338 describes in this respect a method for the preparation of such a hybrid material by condensation of a silicate sol, that is to say a sol comprising oligomers of silicon oxide, according to the sol-gel method. However, the optical and mechanical properties of such a material often degrade rapidly, so that these materials do not always provide optimal protection of an optical sensor within a nonlinear optical device.

### SUMMARY OF THE INVENTION

It is an object of the invention to provide an optical structure with non-linear optical properties to overcome the disadvantages described above.

The invention aims in particular to provide such an optical structure having improved optical and mechanical properties compared to the optical structures of the state of the art.

To this end, according to one aspect, the invention proposes an optical structure comprising at least one stack comprising, a central filter and two optical elements between which said central fitter is interposed. Said central fitter is in a matrix material, said matrix material being doped with at least one doping agent. The central filter and the two optical elements on either side thereof are assembled by bonding layers of a material based on the same as the matrix material as to that of the central fitter, the optical elements on either side of the central filter and the bonding layers each having a refractive index equal to that of the material of the central filter or only differing from this refractive index within a range of plus or minus 0.05, preferably within a range of plus or minus 0.02.

The doping agent is an optical limiting doping agent, i.e. is a power limiting agent. The doping agent in combination with the optical elements of the optical structure is such that it limits power transmission. The doping agent imparts a power transmission threshold (protection threshold mentioned below) to the structure.

Such an optical structure may be used as protective structure or protective device. it can be used to protect another device or eyes from a laser radiation, for example.

The optical structural has non-linear optical properties, which are defined by the fact that the higher the energy input is, the higher the absorption of energy by the structure is. The percentage of energy absorption of the structure increases with the energy input.

Surprisingly, such a structure according to the invention improves significantly the protection threshold (as shown below from FIG. 6) in comparison to a case having only the central filter without the optical elements. It also improves both the transmission of wavelengths of low energy in a transmission window of wavelengths (as shown below from FIG. 5), and has a higher Laser induced Damage Threshold in comparison to the case having only the central filter without the optical elements.

Furthermore, such a structure in which a doped material is interposed between two optical elements makes it possible to limit the diffusion of oxygen in the doped material and to ensure better beam focusing.

In addition, it avoids the darkening of the doped material that may be encountered with certain adhesives in case of dopants sensitive to the substances contained in the adhesives.

It thus provides a structure with excellent optical properties and limited optical tosses since the index between the doped material and the adhesive is identical, or at least has a tow gradient of difference.

According to an embodiment of the invention, the optical structure has non-linear optical properties.

According to an embodiment of the invention, the matrix material is a sol-gel matrix material. In this embodiment, the material of the central filter is a sol-gel matrix material in which is(are) incorporated the doping agent(s).

According to an embodiment of the invention, the sol-gel matrix material being doped with the doping agent(s) of the central filter is a hybrid or inorganic polymer obtained by inorganic polymerisation of a base precursor material in presence of the doping agent(s).

According to an embodiment of the invention, the matrix material may be a silicon oxyde based matrix.

According to an embodiment of the invention, the sol-gel matrix material doped with the doping agents) of the central filter is a material made by condensation of a silicon-based sol (silicone oxyde based material), that is to say a sol comprising oligomers of silicon oxide, in presence of the doping agent(s).

For example, the sol-gel matrix material being doped by the doping agent(s) of the central filter is obtained by the following steps. A sol of oligomers of silicon oxide and of the doping agents) is dispersed in a solvent and is liquid at low temperature or ambient temperature. Then the sol is condensed to form a gel. The solvent is then extracted to obtain the solid material.

According to an embodiment of the invention, there may be several doping agents in the central fitter.

According to an embodiment of the invention, at least a front face of the structure is covered with an anti-reflective layer.

According to an embodiment of the invention, the stack comprising the central filter and the two optical elements between which said central filter is interposed, is sandwiched between two silica glasses, among which at least the front glass is covered with the anti-reflective layer.

According to an embodiment of the invention, the central filter and the optical elements between which it is interposed are each between 0.5 mm and 10 mm thick, advantageously between 0.75 mm and 3 mm.

According to an embodiment of the invention, the doping agent is such that the optical structure has a transmitted energy lower than 3 μJ for an energy input of 50 J/cm².

According to an embodiment of the invention, the doping agent is such that the optical structure limits transmitted energy to lower than 3.5 μJ.

According to an embodiment of the invention, the doping agent. is such that the optical structure limits transmitted energy to lower than 3.5 μJ for an energy input of 0 to 100 J/cm².

According to an embodiment of the invention, the doping agent is such that the optical structure has a Laser induced Damage Threshold higher than 150 J/cm², or higher than 200 J/cm².

According to an embodiment of the invention, the doping agent has a doping concentration of 0.1 to 500 mM, or of 0.1 to 100 mM, or of 1 to 100 mM.

According to an embodiment of the invention, for a transmission window of wavelengths of visible light the doping agent has a doping concentration of 5 mM to 500 mM and more preferably from 10 mM to 70 mM.

According to an embodiment of the invention, for a transmission window of wavelengths of near-infrared the doping agent has a doping concentration of 1 mM to 500 mM and more preferably from 1 mM to 100 mM.

According to an embodiment of the invention, the doping agent has a doping concentration of 20 mM to 50 mM, or of 30 mM to 50 mM for a base material of silicon oxyde in the matrix material of the central filter.

According to an embodiment of the invention, the optical elements between which the central filter is interposed are in an undoped material.

According to an embodiment of the invention, the optical elements between which the central filter is interposed are in an undoped material based on the same matrix material as that of the central fitter, i.e. without the doping agent(s). The above embodiments described may then apply to the material of the optical elements but without the doping agent(s). Especially, the optical elements may be in the same sol-gel material as the central filter but without the doping agent(s).

According to an embodiment of the invention, the optical elements between which the central fitter is interposed are in an undoped material of fused silica glass.

According to an embodiment of the invention, the sol-gel matrix of the central filter and of the bonding layers is preferably selected within the following group of materials: methyltrimethoxysilane (MTMOS), methyltriethoxysilane (MTEOS), ethyltriethoxysilane (ETEOS), dimethyldimethoxysilane (DMDMOS), phenyltrimethoxysilane (PTMOS), dimethyldiethoxysilane (DMDEOS), (3-Glycidyloxypropyl)trimethoxysilane (GLYMO), (3-Glycidoxypropyl) methyldimethoxysilane (GLYDMO), 2-(3,4-Epoxycyclohexyl)ethyltrimethoxysilane, 2-(3,4-Epoxycyclohexyl)ethyl(methyl)dimethoxysilane, diethoxymethylsilane (HMDEOS), phenyltriethoxysilane (PTEOS), vinyltriethoxysilane (VTEOS), (3-Glycidyloxypropyl)trimethoxysilane (GLYEO), (3-Glycidoxypropyl) methyldiethoxysilane (GLYDEO), 2-(3,4-Epoxycyclohexyl) ethyl(methyl)diethoxysilane and 2-(3,4-Epoxycyclohexyl)ethyltriethoxysilane, and their mixtures, advantageously methyltriethoxysilane (MTEOS), ethyltriethoxysilane (ETEOS) and their mixtures.

The sol-gel matrix of the bonding layers can for example be methyltriethoxysilane (MTEOS), with a concentration of methyltriethoxysilane (MTEOS) in its solvent higher than 80% in weight, advantageously between 82 to 90% in weight.

The doping agent can he any functional entity that will confer specific optical properties of limitation of power transmission to the material.

According to an embodiment of the invention, the doping agent is a visible and/or Near Infra-Red photochromic and/or optical power limiting agent.

Photochromic agents and optical power limiting agents are examples of such doping agents. The doping agents may be chosen among organic, organometallic or inorganic molecular species, as well as among inorganic nanomaterials. The solubility of the organic or organometallic doping agents incorporated must be high enough in the solvent that is compatible with the sol. In some cases, supplementary quantities of solvent are introduced in the sol to completely dissolve the organic or organo-metallic doping agent. Increasing temperature of the sol can play the same rote. Mixtures of doping agents can easily be achieved using this process, even if they present different solubilities.

Of course, the doping agent may be other than the examples described.

Depending on the bandwidth to be covered, a single molecule or a mixture of a plurality of molecules can be used to cover all the necessary wavelengths. Typically, a mixture of 2 or 3 doping molecules can be used for large bandwidth in the visible field, whereas a single doping molecule can be contemplated for protection of small bandwidths in the near infrared.

According to an embodiment of the invention, for visible wavelengths, preferred doping agents can be selected within the following group:

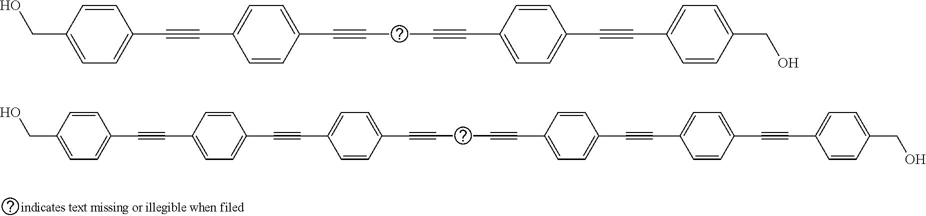 [SMILES: OCc1ccc(C#Cc2ccc(C#CCC#Cc3ccc(C#Cc4ccc(CO)cc4)cc3)cc2)cc1 ; OCc1ccc(C#Cc2ccc(C#Cc3ccc(C#CCC#Cc4ccc(C#Cc5ccc(C#Cc6ccc(CO)cc6)cc5)cc4)cc3)cc2)cc1]

(also named PE2 and PE3 in the following text) or their mixtures.

Other doping agents can be contemplated, such as oligofluorene (for visible wavelengths) or non-linear absorbing chromophores (azabodipy) for wavelengths in the near infra-Red field, or others.

According to an embodiment of the invention, the central filter and the optical elements between which it is interposed are each between 0.5 mm and 10 mm thick, advantageously between 0.75 mm and 3 mm. They are typically of a thickness equal to 1 or 2 mm.

The invention also proposes a method of manufacturing the optical structure, wherein the central filter and the two optical elements on either side thereof are bonded at a temperature between 45° C. to 120′C, advantageously between 50° C. and 70° C., and under a pressure of between 0.1 to 30 Kg/cm², advantageously between 5 and 20 Kg/cm².

According to an embodiment of the invention, said method uses a temperature-regulating press. The central fitter and the two optical elements on either side thereof are bonded using a temperature-regulating press.

### BRIEF DESCRIPTION OF THE DRAWINGS

Other characteristics and advantages of the invention appear from the following description of particular embodiments of the invention, given as non-limiting examples, and with reference to the accompanying drawings, in which:

FIG. 1 is a schematic representation of an optical structure according to the invention;

FIG. 2 presents the transmission spectra obtained with and without anti-reflective layers;

FIGS. 3a and 3b are schematic section views of the optical structure of a first sample used in a comparison test;

FIGS. 4a and 4b are schematic section views of the optical structure of a second sample used in said comparison test;

FIG. 5 is a graph on which the transmission curves of the samples of FIGS. 3a, 3b and 4a, 4b are provided;

FIG. 6 provides the transmitted energy versus the laser energy input tested for the same samples at 532 nm wavelength.

### DETAILED DESCRIPTION OF EMBODIMENTS

### Optical Structure

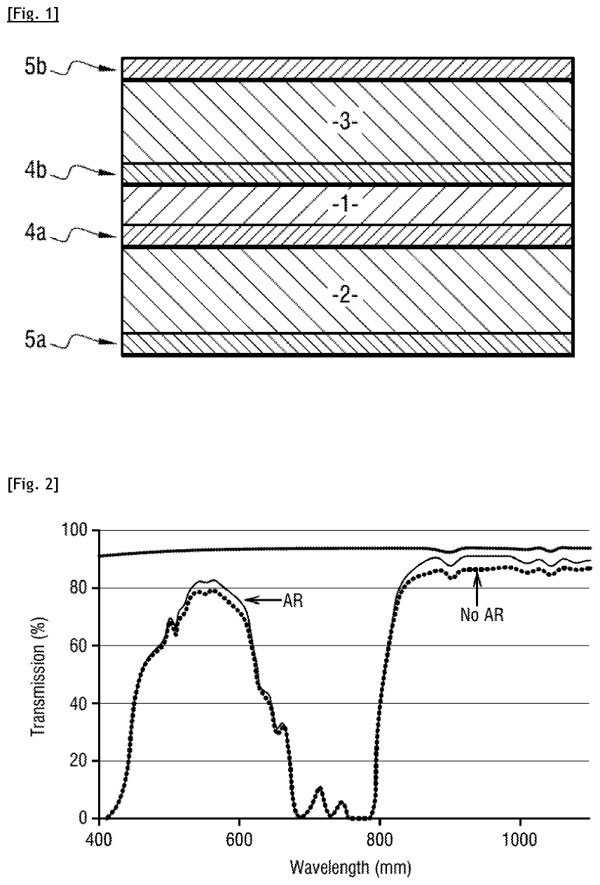

The structure shown in FIG. 1 is a stack comprising:
a central filter 1.
sandwiching optical elements 2 and 3 between which the filter 1 is interposed,
layers of adhesive 4a and 4b interposed between the central filter 1 and, on the one hand, optical element 2 (adhesive layer 4a) and, on the other hand, optical element 3 (adhesive layer 4b),
anti-reflective layers 5a and 5b deposited on the Layers 2 and 3.

The central filter 1 and the optical elements 2 and 3 are for example each of a thickness between 0.5 mm and 10 mm, typically of a thickness of the order of 1 or 2 mm.

For example, the central filter 1 is 1 mm thick, while the two optical elements 2 and 3 are 2 mm thick.

Different diameters are possible for filter 1 and the sandwiching optical elements 2 and 3. By way of example, a typical filter diameter is of the order of 1 cm (2 cm in diameter for example).

### Central Filter 1

According to an embodiment of the invention, central fitter 1 comprises a silica-based sol-gel matrix, i.e. a matrix material having a base material of silicon oxyde, which incorporates optical chromophores limiting transmission of power.

The matrix allows good transmission properties at visible, NIR or IR wavelengths, whereas the incorporated chromophores are chosen to block either high intensity visible or NIR wavelengths typically from 380 nm and up to 1800 nm.

In the present disclosure, visible wavelengths may be a transmission window of wavelengths from 450 nm to 650 nm, NIR (near infrared radiation) may be a transmission window of wavelengths from 750 nm to 3500 nm, especially in the transmission window of wavelengths of 800 nm to 1700 nm or 1800 nm, especially of 1400 to 1600 nm or around 1500 nm, and IR (infrared) wavelengths may be a transmission window of wavelengths of 750 nm to 15 μm.

### Inorganic Matrix

According to an embodiment of the invention, the inorganic matrix is for example of the type described in the previous application WO2011128338. The following monomer materials can be mentioned: methyltrimethoxysilane (MTMOS), methyltriethoxysilane (MTEOS), ethyltriethoxysilane (ETEOS), dimethyldimethoxysilane (DMDMOS), dimethyldiethoxysilane (DMDEOS), diethoxymethylsilane (HMDEOS), phenyltriethoxysilane (PTEOS) and vinyltriethoxysilane (VTEOS).

Mixtures of these materials can also be contemplated.

In an embodiment, the monomer is selected among methyltriethoxysilane, ethyltriethoxysilane and their mixtures.

According to an embodiment of the invention, the solvent is an alcohol and may be advantageously ethanol.

WO 00/35818 can be consulted for more details.

### Incorporated Doping Agent

According to an embodiment of the invention, for visible wavelengths, a doping agent limiting transmission of power can be a platinum-based chromophore such as those proposed in WO201128338, for example, a platinum phenylacetylure corresponding to the following formula

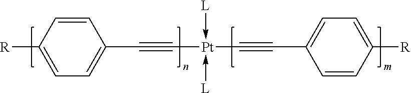

where:
n and m are chain lengths,
L denote ligands generally of phosphine type,
R denotes terminal groups, typically —H, —OH or groups improving solubility as t-Bu3.

Advantageously, n and m are 2 or 3, L is PBu₃ and R is CH₂ OH,

According to an embodiment of the invention, the chromophores for the visible range are:

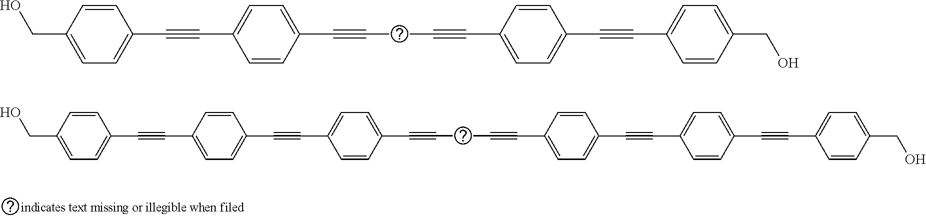 [SMILES: OCc1ccc(C#Cc2ccc(C#CCC#Cc3ccc(C#Cc4ccc(CO)cc4)cc3)cc2)cc1 ; OCc1ccc(C#Cc2ccc(C#Cc3ccc(C#CCC#Cc4ccc(C#Cc5ccc(C#Cc6ccc(CO)cc6)cc5)cc4)cc3)cc2)cc1]

respectively named PE2 and PE3 in all the present text. In an embodiment PE2 is present with PE3. In other embodiments, the central filter is doped with PE2 without PE3. In other embodiments, the central filter is doped with PE3 without PE2.

Typical doping concentrations can be
from 1 to 500 mM for PE2, preferably from 10 mM to 400 mM and more preferably from 20 mM to 70 mM;
from 0.1 to 100 mM for PE3, preferably from 1 mM to 50 mM and more preferably from 5 mM to 30 mM.

Inorganic matrix with those doped chromophores typically have a high transmittance within the visible domain (between 450-700 nm), as well as good absorption properties in a range between 700 and 800 nm.

Other doping agents can be contemplated, such as oligofluorene (for visible wavelengths).

According to an embodiment of the invention, non-linear absorbing chromophores belonging to the azabodipy family and incorporated into a sol-gel monolithic matrix can also be used for wavelengths in the near Infra-Red region (between 1200 and 1600 nm).

They provide a maximal efficiency around 1300 nm.

Examples of such non-linear chromophores are described in:

“Efficient hybrid materials for optical power limiting at telecommunication wavelengths—Denis Château, Quentin Bellier, Frederic Chaput, Patrick Feneyrou, Gérard Berginc, Olivier Maury, Chantal Andraud and Stephane Parola—Mater. Chem. C, 2014, 2, 5105-5110.

### Optical Elements 2 and 3

According to an embodiment of the invention, optical elements 2 and 3 are of a glass material based on the same sol-gel matrix material as that of the central filter.

They are undoped.

Their refractive index equals that of central filter 1 or only differ from it within a range of plus or minus 0.05 (preferably plus or minus 0.02).

### Bonding, layers 4a, 4b

The adhesive material used to bond central filter 1 with the two optical elements 2 and 3 is chosen with a refractive index approximately equal to that of the central lifter hybrid material plus or minus 0.05, preferably plus or minus 0.02.

Using an identical index between the central filter material and the adhesive material (or at least a low index gradient between the central filter material and the adhesive) helps to limit optical losses and allows a good focusing.

According to an embodiment of the invention, the adhesive material is chosen of the same sol-gel matrix material as that of the central filter 1.

The chromophores which may be present in the central filter 1 might be sensitive to many substances contained in adhesives, causing potential yellowing or even browning of doped materials.

The choice of an adhesive material in the same matrix of sol-gel matrix material as that used for the central filter 1 avoids this problem and allows to obtain very good optical properties (see experimental results here after).

The ellipsometry measurements show the low influence of doping on the refractive index and, therefore, the variations in indices in the assembly are limited.

According to an embodiment of the invention, the sol-gel matrix of the bonding layers is preferably concentrated (at least 80% in weight) to obtain a viscous adhesive, allowing adherence at low temperature.

### Anti-Reflective Layers 5a, 5b

According to an embodiment of the invention, anti-reflective layers 5a, 5b can be of classical antireflective compounds such as those described and proposed in WO2009133264.

According to an embodiment of the invention, they can also be coatings obtained through sol-gel techniques, the mineral alkoxide which is used being for example a tetraalkoxysilane, preferably tetramethoxysilane (acronym TMOS), and/or else further a tetraethoxysilane (or TEOS) as proposed in WO2010034936.

According to an embodiment of the invention, they are advantageously provided—as shown in FIG. 1—on each of the free faces of the stacking that constitutes the optical structure.

In a possible embodiment, only the front face of the structure has an anti-reflective layer (as it is the one which is the most submitted to potential damages).

### Assembly Process

The following describes assembly examples for an optical structure of the type here above mentioned.

According to an embodiment of the invention, in these examples, optical elements 2 and 3 and bonding layers 4a, 4b are in MTEOS, while the central filter 1 contains a mixture of PE2 and PE3 dopants (MTEOS doped PE2 50 mM and PE3 10 mM).

According to an embodiment of the invention, bonding layers 4a and 4b are made from a sol-gel matrix of MTEOS, which is concentrated 96% in mass in ethanol by vacuum evaporation and solvent change.

According to an embodiment of the invention, this sol-gel matrix is used as adhesive to assemble optical elements 2 and 3 to filter 1 (bonding layers 4a, 4b).

According to an embodiment of the invention, a pressure of about 60 g/cm² is applied for 72 hours at 45° C. to ensure adhesion.

Alternatively, in another implementation, the bonding occurs:
at higher temperatures to allow faster drying of the adhesive and
at greater pressure so that the layers of adhesive are thinner.

A press with temperature control is used to ensure reproducibility.

This press is, for example, a manual press.

It allows a controlled pressing at a temperature between 50° C. to 70° C., advantageously between 55° C. and 65° C., typically 60° C., which permits a rapid evaporation of ethanol which is the solvent of the MTEOS matrix used.

The bonding pressure is much greater than the conventional bonding pressure and is typically between 0.1 and 30 kg/cm², advantageously between 10 and 20 Kg/cm².

It will be noted in general that the proposed inorganic matrices—and in particular the matrices of MTEOS—have a very good mechanical strength under pressure. The matrices of MTEOS support up to 2 T/cm² pressures.

Such a bonding makes it possible to obtain bonded materials, with a good transparency in the visible wavelengths, and especially to achieve the assembly of the filter and the sandwiching optical elements simultaneously in only 1 h 30, i.e. a time saving of 6 days.

Other adhesive compositions are possible, especially glues with a tower concentration in the gel.

According to an embodiment of the invention, typically, for MTEOS matrices, the concentration in ethanol can be between 82% and 90% (86%+/−4%).

This makes it possible to work under the conditions indicated above with a better distribution of the adhesive.

The bonding at high pressure limits the risk of cracks due to the formation of bubbles in the material.

According to an embodiment of the invention, the anti-reflective layer or layers 5a, 5b are deposited in a conventional manner, by prior deposition on the Layers 2 and/or 3.

In an alternative embodiment, the stack comprising filter 1 and bonded optical elements 2 and 3 between which filter 1 is interposed can be sandwiched between neutral silica glasses. Among the two sandwiching glasses, at least the front surface of the front glass is covered by an anti-reflective layer.

### EXPERIMENTAL RESULTS

The structures thus manufactured have a very good optical quality.

They allow excellent results in optical limitation of power transmission, with a substantive improvement of the overall performance of the system.

Two examples S1 and S2 described below of an optical structure according to the invention have been tested in comparison to a reference sample R of prior art (described below).

A better protection threshold of transmitted energy for the optical structure according to the invention has been noted, together with a higher Laser induced Damage Threshold. The global transmission quality is also improved.

The transmission losses are very low (at most of the order of 0.5% in the visible range) between the doped material and the assembly which is five times thicker. This shows the good behavior of the bonding layers as well as the excellent transparency of undoped materials.

FIG. 2 further presents the transmission spectra obtained with and without anti-reflective layers (“AR” and “No AR”) and shows that anti-reflective layers 5a, 5b also allow improvement of the optical quality.

### EXAMPLES

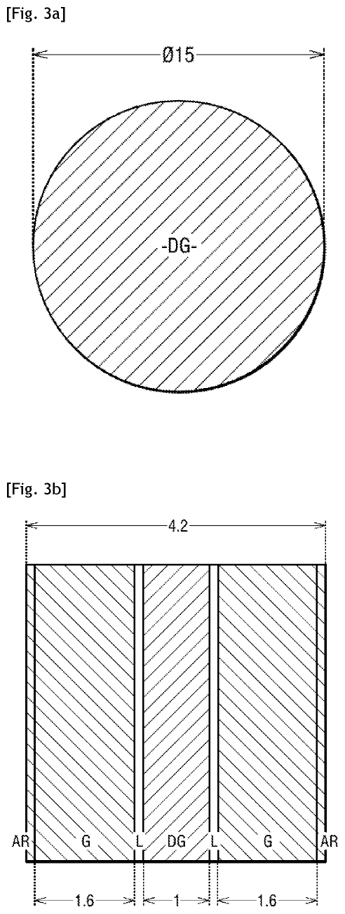

### Sample S1 (FIGS. 3a and 3b)

An optical structure of 15 mm diameter has been tested, said optical structure comprising a central filter DG of doped glass sandwiched between two neutral optical elements G.

The doped central filter DG was of MTEOS based matrix doped with a mixture of PE2 and PE3 (PE2 50 mM, PE3 10 mM).

It presented a thickness of 1 mm.

Neutral optical elements G were of pure silica, i.e. commercial fused silica glass (not the material of DG and not in a sol-gel material).

They presented a thickness of 1.6 mm.

They were adhered to filter DG through bonding layers L of EPO-TEK OG175 from EPOXY TECHNOLOGY INC., USA (said bonding layers being thus not made of a material with an MTEOS matrix, as is the case with the doped central filter).

Width of the optical structure obtained is 4.2 mm.

The silica glasses G were covered with anti-reflective layers AR on their external faces AR.

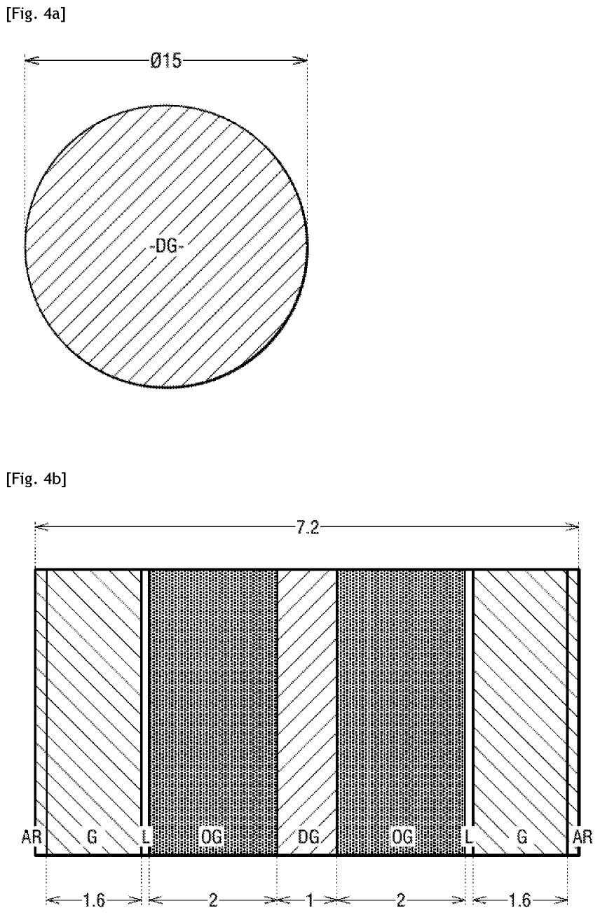

### Sample S2 (FIGS. 4a and 4b)

Sample S2 has a central filter 1, DG made in the above-mentioned MTEOS based matrix doped by a doped material corresponding to those here-above mentioned (PE2 50 mM, PE3 10 mM), sandwiched between two neutral optical elements 2, 3, OG, which were of the same MTEOS based matrix as of the central filter DG but were undoped.

The optical elements OG are 2 mm thick, whereas the central filter 1, DG is 1 mm thick. The structure has 15 mm diameter.

Bonding between the central filter DG and the sandwiching optical elements OG has been achieved through the assembly process here above described using an adhesive material of the same MTEOS matrix as that of the central filter DG and of the sandwiching undraped optical elements OG.

The optical structure obtained has further been sandwiched between two commercial pure silica glasses G (1.6 mm thick), i.e. commercial fused silica glass (not the material of DG and not in a sol-gel material). The silica glasses G were covered with anti-reflective layers AR on their external faces.

The bonding between glasses G and optical elements OG is realized through the same commercial adhesive material as that used for sample S1 (layers L).

### Reference Sample R of a Typical Prior Art Limitation Optical Structure

The reference sample R of a typical prior art is the DG central filter of doped MTEOS based matrix doped with a mixture of PE2 and PE3 (PE2 50 mM, PE3 10 mM) but taken alone, which is 1 mm thick and which is the same DG central filter as that of sample S2, i.e. the sample S2 without the optical elements OG, without the adhesive material L, without the two commercial pure silica glasses G and without the anti-reflective layers AR.

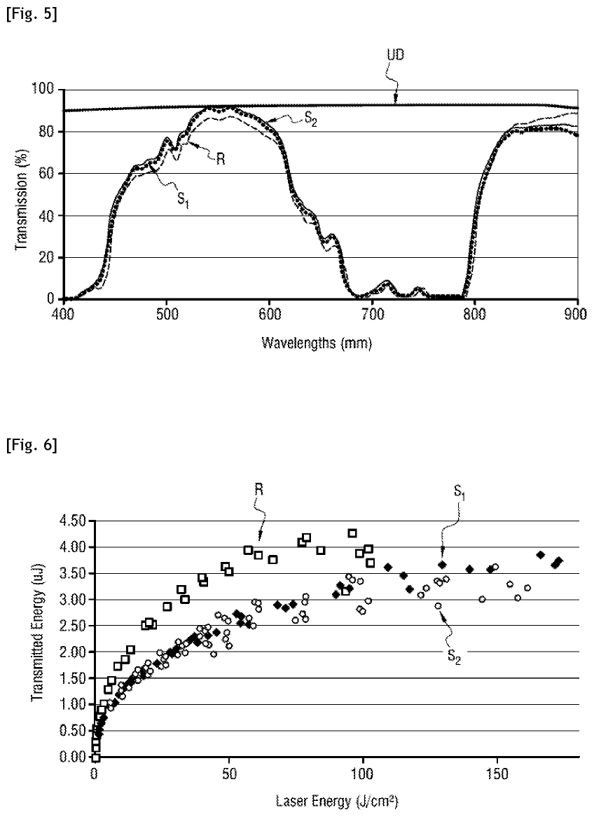

Transmission curves are provided on FIG. 5 for the three examples S1, S2 and R for low energy input, whereas FIG. 6 provides the transmitted energy versus the laser energy input for laser energy input reaching high values in abscissa for the three examples S1, S2 and R. In FIG. 5, the transmission curve UD of the commercial fused silica glass G (1.6 mm thick) taken alone, for low energy input is also shown.

Sample S2 has the best transmission curve, both samples S1 and S2 having a better transmission response than the reference sample R of typical prior art limitation optical structure (FIG. 5) in a transmission window of wavelengths of 450 nm to 650 nm, corresponding to visible light. The gain in the transmission curve (FIG. 5) is of several %, which may be required and important for some applications when combined with the decrease of transmitted energy according to FIG. 6.

From FIG. 6, the reference sample R allows a transmitted energy of 4-4.5 μJ, whereas samples S1 and S2 allow a transmitted energy of 3-3.5 μJ, at Least from 0 to 100 J/cm² of energy input.

From FIG. 6, the transmitted energy at 50 J/cm² of samples S1 and S2 is lower than 3 μJ (equal to 2.1-2.7 μJ), while the transmitted energy at 50 J/cm² of the reference sample R is higher than 3.50 μJ (equal to 3.5-3.7 μJ). Thus, the samples S1 and S2 according to the invention advantageously provide a decrease of 25% of transmitted energy of the optical structure, for a same incident laser energy of 50 J/cm², and thus have a protection threshold of transmitted energy (which can be defined by the absorbed energy from FIG. 6) which is 25% higher (and then better) than the reference sample R of prior art. The samples S1 and S2 thus improve significantly limitation of power transmission (see FIG. 6) in comparison to the reference sample R having only the central filter without the optical elements. The samples S1 and S2 also improve both the transmission of wavelengths of tow energy in a transmission window of wavelengths (as shown from FIG. 5), and have a higher Laser Induced Damage Threshold in comparison to the reference sample R having only the central filter without the optical elements.

The Laser Induced Damage Threshold (LIDT) was tested at 532 nm wavelength, with pulses of 5.5 nanoseconds and with the focus in the middle of the samples (for every laser pulse the sample was moved).

The Laser Induced Damage Threshold for reference sample R of prior art is −100 J/cm² and damage occurs at the front entrance, as also shown on FIG. 6.

The Laser Induced Damage Threshold is around 160-190 J/cm². for sample S1 (damage in the commercial bonding Layer L at the front).

The Laser Induced Damage Threshold is considerably improved (−250 J/cm²) with sample S2 using a bonding layer with the same sol-gel matrix as that of the central doped filter DG (see FIG. 6) (damage in the commercial bonding layer L at the front).

1. Optical structure comprising at least one stack comprising a central filter and two sandwiching optical elements between which the central filter is interposed, wherein the central filter is in a matrix material, the matrix material being doped with at least one doping agent, the central filter and the two sandwiching optical elements on either side thereof being assembled by bonding layers of a material based on the same matrix material as the matrix material of the central filter, the optical sandwiching elements on either side of the central filter and the bonding layers each having a refractive index equal to that of the material of the central filter or only differing from this refractive index within a range of plus or minus 0.05, preferably within a range of plus or minus 0.02.

2. Optical structure according to claim 1, wherein the sandwiching optical elements between which the central filter is interposed are in an undoped material based on the same matrix material as the matrix material of the central filter.

3. Optical structure according to claim 1, wherein the sandwiching optical elements between Which the central filter is interposed are in an undoped material of fused silica glass.

4. Optical structure according to claim 1, wherein the matrix material of the central filter and of the bonding layers (4a, 4b) is selected within the following group of materials: methyltrimethoxysilane, methyltriethoxysilane, ethyltriethoxysilane, dimethyldimethoxysilane, phenyltrimethoxysilane, dimethyldiethoxysilane, (3-Glycidyloxypropyl)triethoxysilane, (3-Glycidoxypropyl) methyldimethoxysilane, 2-(3,4-Epoxycyclohexyl)ethyltrimethoxysilane, 2-(3,4-Epoxycyclohexyl)ethylmethyl)dimethoxysilane, diethoxymethylsilane, phenyltriethoxysilane, vinyltriethoxysilane, (3-Glycidyloxypropyl)trimethoxysilane, (3-Glycidoxypropyl) methyldiethoxysilane, 2-(3,4-Epoxycyclohexyl) ethyl(methyl)diethoxysilane and 2-(3,4-Epoxycyclohexyl)ethyltriethoxysilane, and their mixtures, advantageously methyltriethoxysilane, ethyltriethoxysilane and their mixtures.

5. Optical structure according to claim 4, wherein the matrix material of the bonding layers is methyltriethoxysilane, with a concentration of methyltriethoxysilane in its solvent higher than 80% in weight, advantageously between 82 to 90% in weight.

6. Optical structure according to claim 1, wherein the at least one doping agent is a visible and/or Near infra-Red photochromic and/or optical power limiting agent.

7. Optical structure according to claim 1, wherein at least a front face of the optical structure is covered with an anti-reflective layer.

8. Optical structure according to claim 1, wherein a stack comprising the central filter and the two sandwiching optical elements between which the central filter is interposed, is sandwiched between a front silica glass and another silica glass, wherein at least the front silica glass is covered with an anti-reflective layer.

9. Optical structure according to claim 1, wherein the central filter and the sandwiching optical elements between which the central filter is interposed are each between 0.5 mm and 10 mm thick, advantageously between 0.75 mm and 3 mm.

10. Optical structure according to claim 1, wherein the at least one doping agent is such that the optical structure has a transmitted energy lower than 3 μJ for an energy input of 50 J/cm².

11. Optical structure according to claim 1, wherein the at least one doping agent is such that the optical structure limits transmitted energy to lower than 3.5 μJ.

12. Optical structure according to claim 1, wherein the at least one doping agent is such that the optical structure limits transmitted energy to lower than 3.5 μJ for an energy input of 0 to 100 J/cm².

13. Optical structure according to claim 1, wherein the at least one doping agent has a doping concentration of 0.1 to 500 mM.

14. A method of manufacturing an optical structure according to claim 1, wherein the central filter and the two sandwiching optical elements on either side thereof are bonded at a temperature between 45° C. to 120° C., advantageously between 50° C. and 70° C., and under a pressure of between 0.1 to 30 Kg/cm², advantageously between 5 and 20 Kg/cm².

15. A method according to claim 14, in which the central filter and the two sandwiching optical elements on either side thereof are bonded using a temperature-regulating press.
